(19) United States
(12) Patent Application Publication
(10) Pub. No.: US 2011/0282889 A1
(43) Pub. Date: Nov. 17, 2011

(54) Method and Device for Distributed Configuration of Telematics Services in Motor Vehicle Systems

(75) Inventors: Christian GERSTBERGER, Germering (DE); Ralph Goeckelmann, Dornstadt (DE); Dirk Lehmann, Ulm (DE); Teodora Guenkova Luy, Ulm (DE)

(73) Assignee: Bayerische Motoren Werke Aktiengesellschaft, Muenchen (DE)

(21) Appl. No.: 13/117,499

(22) Filed: May 27, 2011

Related U.S. Application Data
(63) Continuation of application No. PCT/EP2009/008051, filed on Nov. 12, 2009.

(30) Foreign Application Priority Data
Nov. 27, 2008 (DE) 10 2008 059 197.1

(51) Int. Cl. G06F 17/30

(52) U.S. Cl. 707/756; 707/E17.005

(57) ABSTRACT

A method and device are provided for computer-supported processing of data, in particular configuration data, for one or more telematics services in a motor vehicle. In the method, the data are prepared in a hierarchical data structure and in a first predefined data format. The data are converted from the first data format into a second data format, in which the data are arranged in a tabular data structure and made available in the motor vehicle for further processing. Finally, the data obtained in the second data format are represented in a text form as data that are readable or to be stored in a persistent form.

### CROSS-REFERENCE TO RELATED APPLICATIONS

This application is a continuation of PCT International Application No. PCT/EP2009/008051, filed Nov. 12, 2009, which claims priority under 35 U.S.C. §119 from German Patent Application No. DE 10 2008 059 197.1, filed Nov. 27, 2008, the entire disclosures of which are herein expressly incorporated by reference.

### BACKGROUND AND SUMMARY OF THE INVENTION

The invention concerns a method and a device for computer-supported processing of data, in particular configuration data, for one or more telematics services in a motor vehicle.

In a motor vehicle, data must be provided for the provision of telematics (data transmission) services, said data including information, for example, concerning the establishment of a setup of a connection to a computer of a service provider, portal access data, vehicle profiles, configuration parameters, or the like. Since in a motor vehicle the resources of its built-in computer (so-called control devices) are limited with regard to their computing power and their storage capacity, the data must be represented such that it has as little demand for storage space as possible and accessing it can be done with as little computing power as possible. Efficient storage of data is also necessary in order that when querying certain data the response times for receipt of the desired data are kept as short as possible. In order to be able to enable the highest possible performance of the computer built into the motor vehicle it is thus desirable that as many as possible or even all the built-in computers can access the stored data. So that this joint access can be ensured and thus the need for storage space can be limited, the support of a jointly understandable data format is necessary, whereby multiple copying of one data set into different formats is also avoided.

It is thus the object of the present invention to specify a method and a device for computer-supported processing of data, in particular configuration data, for one or more telematics services in a motor vehicle, that method and device meeting the requirements stated above.

This and other objects are achieved according to the invention by a method, device and program for computer-supported processing of data, in particular configuration data for one or more telematics services in a motor vehicle. According to the invention, the data are prepared in a hierarchical data structure (that is, a data tree) and in a first predefined data format. The preparation of the data in the first data format can, for example, be done on a computer of the provider of the telematics service. The data are then converted from the first data format into a second data format by the data being arranged in one or more tabular data structures that contain the contents of the first data format but no longer the hierarchical structure. They are made available in the motor vehicle for further processing. Finally, the data contained in the second data format are reproduced in a text data structure as readable format or as a persistent database.

According to one aspect of the method according to the invention the data are prepared in the first data format according to an XML (extensible markup language) specification, that is, in the XML format. In so doing, the data are in the hierarchical data structure. The tabular data structure is generated from this and made available in the motor vehicle. One of the commonly used communication systems in the automotive infotainment field is the MOST (media-oriented systems transport) 0. MOST is a vehicle-specific architecture for metadata and media transmission. Thus, the generated data structures correspond to objects that can be transmitted via MOST and can be used in the different motor vehicle computers.

The adaptation of the general XML formats to the MOST technology customary for the vehicle makes it possible for computers of the motor vehicle to access the data directly so that great performance can be achieved without intermediate formatting and intermediate storage of the data. Furthermore, due to the computing power and the special operating system in the vehicle, it is also not possible to use standard XML auxiliary tools since the vehicle environment is not suitable for them or does not have sufficiently high performance. For example, the use of DOM parsers (described in 0 and 0) requires an intermediate representation as an object tree. A standard XML validator requires the loading of an additional model for the data processing and validity checking of the instance data set. Thus this invention is based only on the use of a simple SAX-based parser (described in 0 and 0) without XML validation using heuristic methods described thereunder.

The customary known XML validity-checking forms include either a complete validation of the data tree or even no validation. However, in order to achieve the target format on MOST a minimum degree of validity checking is necessary. In order to get around having to perform the customarily necessary complete validation of data in XML format, it is provided according to an additional development that the data in the first predefined data format are represented in a predefined data model that has a data structure known in advance. In particular, the data model includes one or more configurations to each of which one or more semantic data blocks can be assigned. As long as the data are still in the first data format, i.e., according to XML specification, one or more XML instance documents are expediently prepared for each configuration on the computer of a service provider. If needed, they are transmitted via Internet technologies to the vehicle computer of the service user. When they have reached the vehicle computer the data must be prepared for the internal configuration of the vehicle control devices for telematics services. The individual data blocks of the configuration have a specific structure that can be represented in corresponding tabular form.

The method according to the invention has the advantage that after the transformation into the second data format, in which the data are arranged in the tabular data structure, the plurality of original XML documents is no longer needed so that the processing in the vehicle is significantly simplified. Moreover, the validation of the data is simplified by the fact that the heuristic validator only needs a concrete recognition of the XML elements at the XML tree root region. The remaining data block can be split. The preparation is based only on the depth of the subtrees. In the description, this heuristic method is called “partial validation.”

Since the data blocks are formal representations of ISO-OSI 0 layers 2-3 (connectivity) and layers 4-7 (services), they have specific structures known in advance that can be specified as a structuring model for MOST objects. In particular, one of the data blocks includes connection data and/or data relating to a connection setup. This data block is also denoted as “connectivity” or connection object. According to a further form of embodiment one of the data blocks includes data relating to services and/or service features. This data block is also denoted as “services” or services object. Another one of the data blocks includes data relating to constraints. It is also denoted as “constraints” or constraints object. The data model that preferably includes all of the stated data blocks already makes simplified administration possible, even in the preparation of data in the first data format. Moreover, the data model makes possible simplified access of the data after their conversion into the second data format and their being made available in the motor vehicle in a data structure corresponding to the hierarchical data structure, where in particular that access can be performed independently by the computer of the motor vehicle.

The data of a data block can be arranged and stored according to a further development in one or more sub-data blocks. In this way a further structuring of the data is possible, whereby data access by the computer of the motor vehicle is further improved. That is, further recognition and validation of the configuration data (up to individual parameters and values in the model) is performed specifically in the telematics services and applications that are the actual user of the configurations. Thereby, the “partial validation” is also a computer and software module-distributed validation unlike customary XML validation methods.

Due to the complexity of the model, the internal MOST representation must also be reproduced in a form readable by a human for debugging and diagnostic purposes. The individual lines of the generated tables can be represented in text as links to the individual parameters. According to the further development, in the second data format a path specification is assigned to each parameter and its associated parameter value, where the path specification includes at least one ID for the relevant data block and the optional sub-data block or sub-data blocks. In the tabular data format a path specification is thus prepended to each parameter of a data block. In this way it is possible on the one hand to reproduce the tabular representation in text form.

When using XPath 0 as the basis for the link representation it is possible to carry out database queries for MOST objects.

According to a further development, the data is transmitted in the first predefined data format from a first computer of a computer network to a second computer of the motor vehicle, in particular wirelessly, and are converted by the second computer of the motor vehicle into the second data format. In other words this means that the transmission of the data from the computer of the service provider to the motor vehicle is done in the first data format, in particular according to XML specification. This has the advantage that the data transmission can be done with known transmission mechanisms. In this way high efficiency can be achieved in the transmission. Since the processing of the data in the first data format for the motor vehicle, however, is cumbersome, the conversion into the second data format is performed by a computer of the motor vehicle, which offers the described advantages in processing.

In particular, after checking the data in the second data format it is checked whether the data model is valid. The checking is done using the tabular data structure. In so doing, the checking of the data model is performed after a, in particular after any, change and/or enhancement of the data in the first data format and subsequent conversion into the second data format. A change and/or enhancement of the data can be performed by corresponding parameters with their parameter value and the path specification either being appended to the data in the second data format or a modified value being overwritten. By contrast, data that is in the XML data format must be updated by a complete overwriting of the entire XML document. In this way, however, an increased expenditure of time in comparison to the procedure according to the invention is necessary for the data transmission and for the processing of the data in the motor vehicle.

The checking of the data model is done in a simple way by the presence of at least one of the IDs of one of the data block being checked. Accordingly, it is sufficient if the data converted into the second data format is checked merely for the presence of a single ID of one of the data blocks. In this way the checking can be done in a simple way and in a short time.

A checking of the consistency of the parameters or parameter values of any one datum does not take place at the time.

It is furthermore provided that a non-validating, event-based parser such as SAX0 and 0 is used for processing the data in the motor vehicle, said parser performing the processing of the data without prior semantic checking and checking only the structure of the XML instances to be processed (only a “well-formedness” 0 0 check is performed). In this way the efficiency and performance of the computer system in the motor vehicle can be increased since the specific semantic checking is performed as needed as a task distributed over several applications and computers (that is, “partial validation”).

According to a further aspect of the invention, the data in the second data format are represented, in particular in the, or by the, same computer or a second computer, in the motor vehicle in a third data format that reproduces a text representation that can be displayed as a format readable by humans or can be stored as a database on a persistent medium.

The invention furthermore includes a computer program product that is stored on a medium suitable for a computer and can be loaded directly into the internal memory of a digital computer or several computers connected to one another in a communications connection, and includes software code segments with which the steps of the method described can be executed when the product is running on the computer or computers.

The invention furthermore provides a device for the computer-supported processing of data, in particular configuration data, for one or more telematics services in a motor vehicle. The device includes a first means for preparing the data of a hierarchical data structure and in a first predefined data format. The device furthermore includes a second means for converting the data into a tabular data structure. Finally, the device includes a third means for preparing the data contained in the second data format in a text form.

In an expedient development the device can have additional means for carrying out the method described above.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic representation of the procedure underlying the method according to the invention;

FIG. 2 shows a data model according to the invention and for representing the data, in particular configuration data; and

FIG. 3 is a schematic representation of an architecture for partial validation of the data.

### DETAILED DESCRIPTION OF THE DRAWINGS

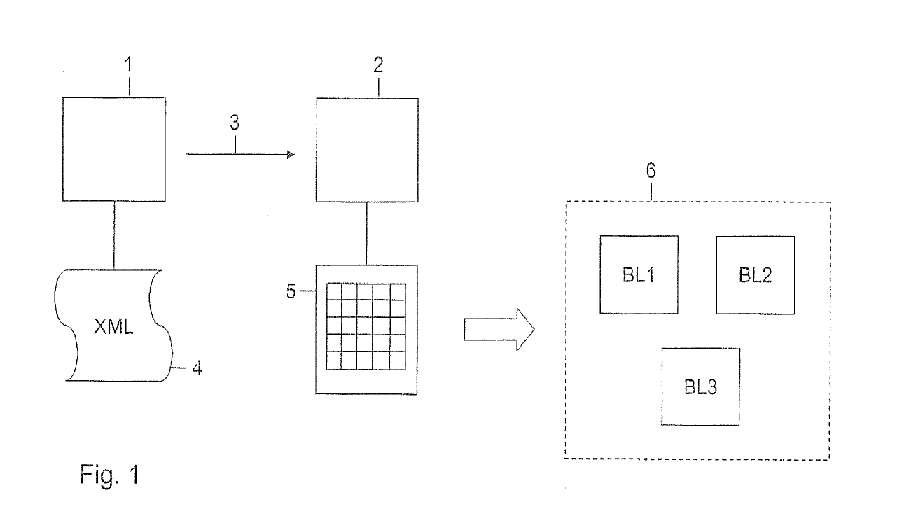

FIG. 1 shows in a schematic representation the procedure underlying the invention. In a computer 1, e.g., a computer of a computer network of the service provider, data, such as, for example, configuration data, for one or more telematics services are prepared in a hierarchical data structure in a first predefined data format. It is expedient if the data in the first data format are prepared as XML data. This is identified by the reference number 4. The data in the first data format are transmitted via a communications link 3, which in particular is implemented wirelessly, to a computer 2 of a motor vehicle. The computer 2 converts the data in the hierarchical data structure and in the first data format into a second data format 5, in which the data are arranged in a tabular data structure. The data are stored by data block (BL1, BL2, BL3). Along with this, the data contained in the second data format 5 are made available to the motor vehicle for further processing or are represented in a third format in the form of text data as a readable format. The organization of the data structures will be explained in more detail further below.

The method will be described in more detail in the following.

Telematics services in the automotive field require communication with an infrastructure providing the services. Along with this, the computer 2 of the motor vehicle and the computer 1 of the infrastructure preferably communicate via wireless communication technologies. In so doing, it must be taken into account in particular that it must be possible to use the corresponding services or applications with different transmission technologies (for example, CSD and GPRS in connection with GSM, UMTS, etc.) and under different service provider environments, such as, for example, roaming. The computer 2 used in the motor vehicle must therefore be able to be implemented with different characteristics to avoid an interruption of an implemented service. In particular, the computer must be in the position to use different transmission technologies and to execute handover. Telematics services used in the automotive field must therefore support the exchange of data with the network infrastructure in different configurations (cf., e.g., T. Guenkova-Luy. “Multimedia Networking—Coordination of Multimedia Services in Next Generation Mobile Networks”, VDM Verlag Dr. Mueller, 2007).

A telematics application comprises three principal configuration types that are associated with different functional abstractions of the services. These are connection configurations, end-to-end performance settings, and constraints relating to them. The constraints represent links between connection configurations (connectivity) and the end-to-end performance configurations that are determined based on hardware configurations, user requirements, and/or provider service level agreements (SLA) with the users (cf. T. Guenkova-Luy. “Multimedia Networking—Coordination of Multimedia Services in Next Generation Mobile Networks”, VDM Verlag Dr. Mueller, 2007); (M. Alfano, N. Radouniklis, “A Cooperative Multimedia Environment with QoS Control: Architectural and Implementation Issues”, ICSI Technical Report TR-96-040, International Computer Science Institute, Berkeley (CA, USA), September 1996); A. Watson, M. A. Sasse, “Measuring Perceived Quality of Speech and Video in Multimedia Conferencing Applications”, Sixth ACM International conference on Multimedia, Bristol (UK), September 1998) and (Y. Ito, Sh. Tasaka, Y. Fukuta “Psychometric Analysis of the Effect of End-to-End Delay on User-Level QoS in Live Audio-Video Transmission”, IEEE International Conference on Communications (ICC2004), Paris (France), June 2004).

Hardware restrictions can, for example, be the availability of a certain NAD module, such as, for example, a GSM or UMTS device. A user restriction can include the permission to activate a certain web address or a telephone service. A provider SLA can, for example, provide that only certain types of transmission technology can be activated although an NAD module can support more or different technologies beyond the technologies stated in the SLA. Configurations of this type are stored in the configuration data of a motor vehicle.

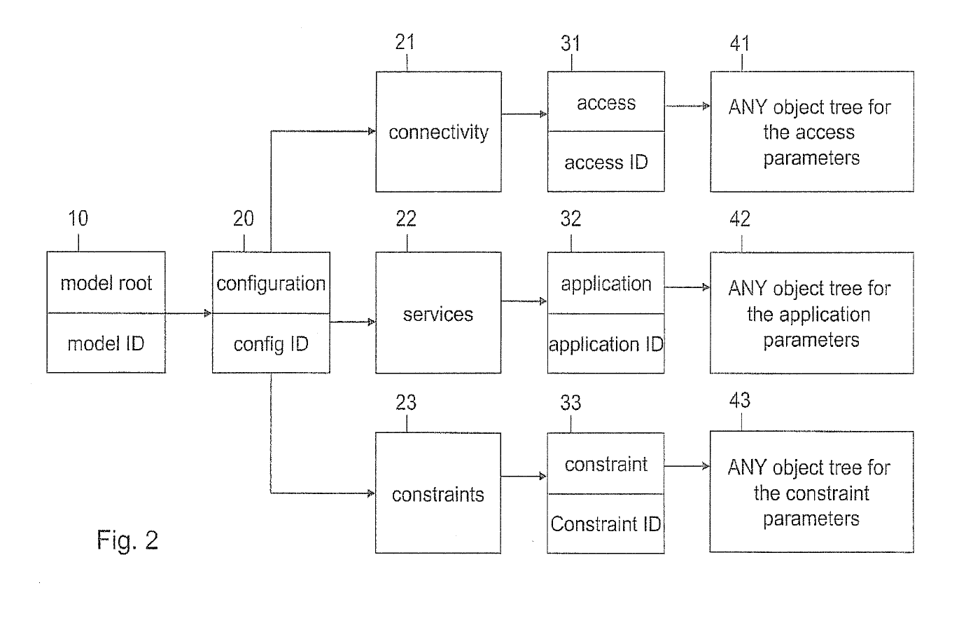

This is accomplished according to the invention by the fact that the data are represented in a predefined data model. This is represented schematically in FIG. 2 in a UML class diagram (see, e.g. (H.-E. Eriksson et al. “Uml 2 Toolkit”, Wiley Publishing, 2004). Alternatively, the model can also be represented by a group of protocols, where some parts of the model belong to a session layer protocol and some parts to a presentation layer protocol attached thereto. This is the case, for example, in SIP (J. Rosenberg et al., “SIP: Session Initiation Protocol”, IETF RFC 3261, June 2002) and SDP (M. Handley, V. Jacobson, C. Perkins, “SDP: Session Description Protocol”, IETF RFC 4566, July 2006).

In FIG. 2, the data or configuration model comprises a root 10 (“model route”) with a unique ID (model ID) that can be used as an ID for the entire model. For example, in the case of a model in the XML specification, the ID can be the name space of the schema or in the case of DTD (document type definition) the name of the DTD model. The model can also be identified by a content-related definition within a protocol and containing the configuration model. This is, for example, described in IANA MIME (IANA, “MIME Media Types”, http://www.iana.org/assignments/media-types/) SIP (J. Rosenberg et al., “SIP: Session Initiation Protocol”, IETF RFC 3261, June 2002), and HTTP (R. Fielding et al., “Hypertext Transfer Protocol—HTTP/1.1”, IETF RFC 2616, June 1999).

The data model can include one or more complete configurations that are represented by a configuration object 20 (“configuration”). The configuration object 20 also includes an ID “Config ID”. Each of the configurations must be identifiable in order to be able to connect the configuration to a specific infrastructure for communication. For telematics applications this can be the layers 2 and/or 3 of the OSI reference model (International Organization of Standardization, International Electrotechnical Commission and International Telecommunication Union, “Information Processing Systems—OSI Reference Model—The Basic Model”, International Standard ISO/IEC 7498-1:1994 and ITU-T Recommendation X.200, 1994), protocol identification, as, for example, GSM SIM (GSM 01.17 V8.0.0 (1991-11), “Digital cellular telecommunications system (Phase 2+); Subscriber Identity Modules (SIM); Functional characteristics”, Technical Specification, No. 1999) or IP addressing (DARPA INTERNET PROGRAM, “Internet Protocol”, IETF RFC 791, September 1981), (S. Deering, R. Hinden, “Internet Protocol, Version 6 (IPv6)”, IETF RFC 2460, December 1998) or the identification of the provider infrastructure via DNS (P. V. Mockapetris, “Domain Names—Concepts and Facilities”, IETF RFC 1034, November 1987).

To the configuration object 20 a connection object 21 (“connectivity”), a services object 22 (“services”), and a constraints object 23 (“constraints”) are connected. These “child” objects represent the above-described classes of configurations that are necessary for a complete end-to-end performance of a telematics service within a specific technology and/or a provider domain. Each of these objects 21, 22, 23 can, in turn, have one or more child configurations.

An access data object 31 (“access”) with an ID (“access ID”) identifies a specific access technology and uses as the ID, for example, the name of the technology (for example, CSD, GPRS, etc.). The access data object 31 belongs to a subtree (41) that describes the parametrization of the access technology. This includes, for example, the name of an access computer for a network, an access point (APN), such as, for example, an IP address, or a selection number or a specific technology performance parameter, such as, for example, a QoS parameter. This information is used in order to configure the telematics system of the motor vehicle in order to produce a connection to the layer 2 and/or 3 of the OSI reference model.

An application object 32 (“application”) with an ID (“application ID”) identifies layer 3 and the accessibility to an end-to-end connection of an infrastructure service, such as, for example, a www portal. Its subtree 42 of objects describes parametrization of the specific applications, such as, for example, www addresses and QoS service states, such as, for example, a retry interval or protocol timeouts.

A constraints object 33 (“constraints”) with an ID (“constraints ID”) identifies specific connections between access elements or applications elements as well as between access and application elements. The subtree elements 43 define configuration states for the execution of the telematics service or a class of similar applications.

This data model enables, in contrast to the validation of an XML document, the partial validation of the data represented by the data model. The specific application for a partial validation arises from the case of distributed telematics applications in which different devices and software parts of the application must be configured by the same model in order to be able to provide data consistency and interoperability. However, the individual devices and software subsystems call on only part of the entire model for their specific configuration.

In such cases the access and the validation of complete XML data module parts cannot be carried out as a whole since corresponding subsystems do not understand or are not permitted to understand certain model parts if they are not necessary for the purposes of the subsystems.

In the invention it is therefore provided that a computer of the motor vehicle does in fact include the complete data model but splits it into data blocks that are provided later as bus-specific models. In particular, they can be provided as MOST-specific content modules (MOST Cooperation, “MOST Media Oriented Systems Transport—Multimedia and Control Networking Technology”, MOST Specification, Rev 2.5, October 2006, http://www.mostcooperation.com/publications/Specifications_Organizational_Procedures/index.html?dir=97). This means that the receiver of a MOST-specific representation of the data model must itself be able to carry out the validation.

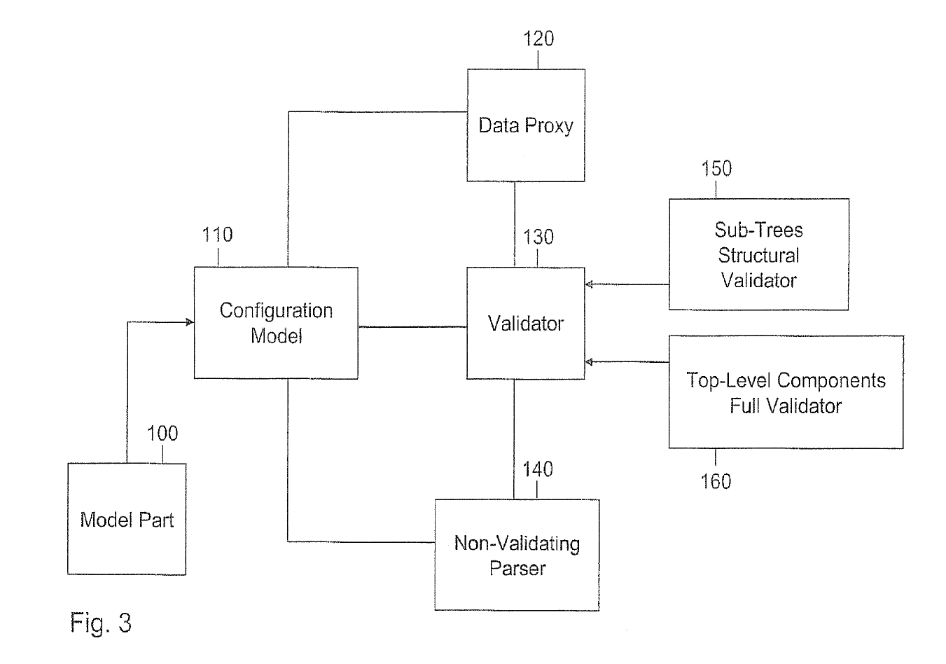

The software architecture for only partial checking of the data transmitted to the vehicle is represented in FIG. 3. The architecture is based on an XML non-validating parser 140. It uses classic XML rules for the validation in order to check the (top-level) structure 160 of the data model. These rules are specified via a configuration model class 110 and correspond to a semantic model validation. The extracted subtrees can be checked structurally (150) by a validator 130 in order to classify data before processing into a format suitable for bus access. The rules for such a procedure are defined as “model part” classes 100. The rules for the subtree validation follow the natural structure of the submodel that is associated with the telematics application.

For example, an application and its parameters can define a two-branch subtree in order to divide the model into an application (as “parent” element), its parameters (as “child” element), and the parameter values (as “element” values).

A more general definition of a structural checking rule is, for example, “an element has at least one “child” element and at least one “grandchild” element, where the “grandchild” element includes no empty value. None of the elements in the structure has no attributes. Such specifications define additional restrictions on a predefined XML infoset (W3C, “XML Information Set (Second Edition)”, W3C Recommendation, February 2004, http://www.w3.org/TR/xml-infoset/). An XML infoset defines the rules for the classic XML well-formedness and the validity confirmation of supporting documents. Such rules can be defined by the reuse of XML schema specifications. The interpretation of a structural validation concerns only the form of the tree, not its contents (cf. also synthetic infoset (W3C, “XML Information Set (Second Edition)”, W3C Recommendation, February 2004, http://www.w3.org/TR/xml-infoset/).

The classic XML representation has a nested structure. This means it has a start and an end element that “envelops” contents of child definitions and/or grandchildren definitions. This is represented by way of example in the following.

<xml>
<configuration>

<connectivity>

```
<conn1>
  <accessnr>+1234567890</accessnr>
  <user>myFunnyUser</user>
  <pwd>myFunnyPWD</pwd>
</conn1>
<conn2>
```

<accessurl>xyz.my-funny-provider.org</accessurl>
<user>myFunnyUser</user>
<pwd>myFunnyPWD</pwd>

</conn2>

```
  </connectivity>
<service>
  ...
</service>
<constraints>
  ...
</constraints>
</configuration>
```

<xml>

In a software entity such contents are customarily represented as an object tree. The transmission of object trees or subtrees can, in the case of applications that share the common XML configuration model, be awkward since the arrangement/unpacking (deserialization) of contents is necessary in order to represent the data for different software entities and different transport media.

Naturally, it is possible that XML contents are also transmitted via MOST. However, this capability assumes that any unit that wishes to use the data has an XML parser and generator. For this reason the invention resorts to a tabular data structure of XML contents that convert the data into a form similar to the form of MOST 0 dynamic arrays. Each individual table represents a configuration block. However, this tabular form cannot be stored in readable or persistent form without additional effort.

For this reason the invention resorts to a linear data structure of XML contents in which the structure “<&>” is used as a separator for the XPaths of individual element contents, as is represented in the following:

/xml/configuration/connectivity/conn1/[accessnr=+1234567890]<&>
/xml/configuration/connectivity/conn1/[user=myFunnyUser]<&>
/xml/configuration/connectivity/conn1/[pwd=myFunnyPWD]<&>
/xml/configuration/connectivity/conn2/[accessurl=xyz.my-funny-provider.org]<&>
/xml/configuration/connectivity/conn2/[user=myFunnyUser]<&>
/xml/configuration/connectivity/conn2/[pwd=myFunnyPWD]<&>

As can be readily inferred from this representation, each entry includes a path specification (here: /xml/configuration/connectivity/conn1/) and a parameter in connection with a value (here, for example, accessnr as parameter and +1234567890 as value). At the end of a given line entry the separator “<&>” is provided. Since the symbols “<”, “>”, and “&” that are used as a separator are XML-reserved symbols (cf. W3C, “XML Primer”, Oxford Brookes University 2002, http://www.w3c.rl.ac.uk/primers/xml/xmlprimer.htm), a backwards compatibility in the re-compilation of the data in linear form into classical XML format is ensured. Moreover, format according to the invention can be put into vector form in a simple manner, as is shown in the following. This is done by a search for the separator “<&>”.

| | |
|---|---|
| 0 | /xml/configuration/connectivity/conn1/[accessnr=+1234567890] |
| 1 | /xml/configuration/connectivity/conn1/[user=myFunnyUser] |
| 2 | /xml/configuration/connectivity/conn1/[pwd=myFunnyPWD] |
| 3 | /xml/configuration/connectivity/conn2/[accessurl=xyz.my-funny-provider.org] |
| 4 | /xml/configuration/connectivity/conn2/[user=myFunnyUser] |
| 5 | /xml/configuration/connectivity/conn2/[pwd=myFunnyPWD] |

The linear data format has a number of advantages in comparison to the customary XML format:

(1) It can be used in software and/or transfer media data containers that correspond to vectors.

(2) The data can be searched and extracted using the XPath convention (cf. W3C, “XML Path Language (XPath), Version 1.0”, W3C Recommendation, November 1999, http://www.w3.org/TR/xpath) in a simple manner since the internal representation is based on separators or in a vector path. This means that only a comparison of strings without any additional breakdown of the data is necessary.

(3) Also, the text form can be transmitted via MOST. This can be used in the case that the conversion of the data into text form and the persistent medium are located in different control devices in the vehicle.

The mechanism for representing configuration data can be used for different MOST devices. For example, the data can be represented on a MOST bus in the form of a dynamic data array. This can, for example, be done in vector form or a classified stream (for example, in linearized form). The streaming of data can be done, for example, using MoCCA middleware from the Harman Becker company (HBAS, “MoCCA User's Guide”, MoCCAUsers-Guide_Version1_{—}9_Release_D2_{—}5.pdf, Revision 1.9 January, 2008) in order to type the data for serial transport. Thus, for example, a new IANA media data type can be defined:

“application/HBMOCCAObject” ( . . . ;” parameter)

Examples of the use of these data types are:

“Content-Type=application/HBMOCCAObject; type=THBVector”

or

“Concent-Type=application/HBMOCCAObject; type=CHBString”

MoCCA can, for example, be used in vehicle-to-vehicle communication. It can be used as a shared agent system between motor vehicles and/or Internet-based infrastructures. In the case in which motor vehicles share telematics platforms, data handling and arrangement mechanisms for configuration data can be carried out via Internet protocols, such as, for example, HTTP or SIP. The specification of a common media type is a prerequisite for interoperability between data transfer systems.

The software that represents the data via a data transfer system includes software parts such as Adapter and Proxy (E. Gamma, R. Helm, R. Johnson, J. M. Vlissides, “Design Patterns; Elements of Reusable Object-Oriented Software”, Addison-Wesley, 1995). However, the interface (API, application programmable interface) for representing transportable substructures depends on the part validation algorithm.

Table of Abbreviations

| Word | Definition |
|---|---|
| APN | Access Point Name |
| CSD | Circuit Switched Data |
| DNS | Domain Name System |
| DTD | Document Type Definition |
| GPRS | General Packet Radio Service |
| GSM | Global System for Mobile communications |
| HMI | Human-Machine Interface |
| HTTP | Hyper-Text Transfer Protocol |
| HW | Hardware |
| IANA | Internet Assigned Numbers Authority |
| Infoset | Information Set |
| IP | Internet Protocol |
| MIME | Multipurpose Internet Mail Extensions |
| MOST | Media Oriented Systems Transport |
| NAD | Network Access Device |
| QoS | Quality of Service |
| SIM | Subscriber Identity Modules |
| SIP | Session Initiation Protocol |
| SLA | Service Level Agreement |
| SW | Software |
| UMTS | Universal Mode Telecommunications System |
| WWW | World Wide Web |
| XML | Extensible Markup Language |

### TABLE OF PUBLICATIONS

[1] T. Guenkova-Luy, “Multimedia Networking—Coordination of Multimedia Services in Next Generation Mobile Networks”, VDM Verlag Dr. Mueller, 2007
[2] M Alfano, N. Radouniklis, “A Cooperative Multimedia Environment with QoS Control: Architectural and Implementation Issues”, ICSI Technical Report TR-96-040, International Computer Science Institute, Berkeley (CA, USA), September 1996
[3] A. Watson, M. A. Sasse, “Measuring Perceived Quality of Speech and Video in Multimedia Conferencing Applications”, Sixth ACM international conference on Multimedia, Bristol (UK), September 1998
[4] Y. Ito, Sh. Tasaka, Y. Fukuta, “Psychometric Analysis of the Effect of End-to-End Delay on User-Level QoS in Live Audio-Video Transmission”, IEEE International Conference on Communications (ICC2004), Paris (France), June 2004
[7] Ch. Valentine, “XML Schemes”, SYBEX, 2002
[8] B. Marchal, “XML by Example”, QUE, 2002
[9] H.-E. Eriksson, at al., “Uml 2 Tookit”, Wiley Publishing. 2004
[10] International Organization for Standardization, International Electrotechnical Commission and International Telecommunication Union, “Information Processing Systems—OSI Reference Model—The Basic Model”, international Standard ISO/IEC 7408-11094 and ITU-T Recommendation X.200, 1994
[11] J. Rosenberg et al., “SIP: Session Initiation Protocol”, IETF RFC 3261, June 2002
[12] M. Handley, V. Jacobson, C. Perkins, “SDP: Session Description Protocol”, IETF RFC 4006, July 2006
[13] LANA, “MIME Media Types”, http://www.iana.org/assignments/media-types/
[14] R. Fielding of al., “Hypertext Transfer Protocol—HTTP/1.1”, IETF RFC 2616, June 1999
[15] GSM 02.17 V8.0.0 (1999-11), “Digital cellular telecommunications system (Phase 2+); Subscriber Identity Modules (SIM); Functional characteristics”, Technical Specification, November 1999
[16] DARPA INTERNET PROGRAM, “Internet Protocol”. IETF RFC 791, September 1981
[17] S. Deering, R. Hinden, “Internet Protocol, Version 6 (IPv6)”, IETF RFC 2460, Dec. 1998
[18] P. V. Mockapetris, “Domain Names—Concepts And Facilities”, IETF RFC 1034, November 1987
[19] MOST Cooperation, “MOST Media Oriented Systems Transport—Multimedia and Control Networking Technology”, MOST Specification, Rev 2.5, Oct. 2006, http://www.mostcooperation.com/publications/Specifications_Organizational_Procedures/index.html?dir=97
[20] W3C, “XML Information Set (Second Edition)”, W3C Recommendation, February 2004, http://www.w3.org/TR/xml-infoset/
[21] W3C, “XML Path Language (XPath), Version 1.0”, W3C Recommendation, Nov. 1999, http://www.w3.org/TR/xpath
[22] W3C, “XML Primer”, Oxford Brookes University 2002, http://www.w3c.rl.ac.uk/primers/xml/xmlprimer.htm
[23] HBAS, “MoCCA User's Guide”, MoCCAUsers-Guide_Version1_{—}9_Release_D2_{—}5.pdf, Revision 1.9 January, 2008
[24] E. Gamma, R. Helm, R. Johnson, J. M. Vlissides, “Design Patterns: Elements of Reusable Object-Oriented Software”, Addison-Wesley, 1995

Table of Reference Numbers

| | |
|---|---|
| 1 | First computer |
| 2 | Second computer |
| 3 | Data transmission link |
| 4 | Data in the first data format |
| 5 | Data in the second data format |
| 6 | Data in the third data format |
| 10 | Root of the configuration model |
| 20 | Configuration object |
| 21 | Connection object |
| 22 | Services object |
| 23 | Constraints object |
| 31 | Access data object |
| 32 | Application object |
| 33 | Constraints object |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for computer-supported processing of data for one or more telematics services in a motor vehicle, the method comprising the act of:
receiving, in the motor vehicle, data prepared in a hierarchical data structure and in a first predefined data format;
converting the data from the first data format into a second data format, in which said data are arranged in one or more tabular data structures and are operatively available for further processing in the motor vehicle; and
reproducing the data in the second data format in a text data structure as one of a readable format and a persistent database.

2. The method according to claim 1, wherein the data received in the first predefined data format is in a first data format according to XML specification.

3. The method according to claim 1, wherein the data in the first predefined data format represent a predefined data model.

4. The method according to claim 3, wherein the predefined data model includes one or more configurations, each having one or more semantic data blocks assigned thereto.

5. The method according to claim 4, wherein one of the one or more semantic data blocks comprise at least one of connection data and data relating to a connection setup.

6. The method according to claim 4, wherein one of the one or more data blocks comprise at least one of services data and data relating to service features.

7. The method according to claim 5, wherein one of the one or more data blocks comprise at least one of services data and data relating to service features.

8. The method according to claim 4, wherein one of the one or more semantic data blocks comprise data relating to constraints.

9. The method according to claim 5, wherein one of the one or more semantic data blocks comprise data relating to constraints.

10. The method according to claim 6, wherein one of the one or more semantic data blocks comprise data relating to constraints.

11. The method according to claim 4, wherein data of the one or more data blocks are arranged and stored in one or more sub-data blocks.

12. The method according to claim 11, further comprising the acts of:
assigning a path specification in the second data format to each parameter and the parameter's associated value, wherein the path specification comprises at least one ID for a relevant data block and an optional one of the one or more sub-data blocks.

13. The method according to claim 1, further comprising the act of:
performing validation of the data, said validation being performed in a distributed manner over at least one of multiple computers and software modules.

14. The method according to claim 1, wherein the acts of receiving the data comprises the act of receiving, in a motor vehicle computer, data transmitted wirelessly from a first computer of a computer network; and
wherein the act of converting the data is carried out by the motor vehicle computer.

15. The method according to claim 14, further comprising the acts of:
checking the data in the second data format; and
subsequently checking whether a data model is valid.

16. The method according to claim 15, wherein the act of checking whether the data model is valid is performed after any change of the date in the first data format and subsequent conversion of the data into the second data format.

17. The method according to claim 15, wherein the act of checking whether the data model is valid comprises checking for a presence of at least one ID of one of one or more data blocks.

18. The method according to claim 2, further comprising the act of:
using a non-validating, event-based parser for processing data in the motor vehicle, said parser performing processing of the data without prior semantic checking and checking only a structure of XML instances to be processed.

19. The method according to claim 1, further comprising the act of:
representing the data in the second data format in the motor vehicle in a third data format, the third data format reproducing a text displayable as a format readable by humans or storable as a database on a persistent medium.

20. The method according to claim 19, wherein the data stored in the third data format are made available by data block for access at a bus level.

21. A computer product, comprising:
a computer readable medium for use in a computer, the computer readable medium having stored thereon program code segments that:
receive, in a motor vehicle, data prepared in a hierarchical data structure and in a first predefined data format;
convert the data from the first data format into a second data format, in which said data are arranged in one or more tabular data structures and are operatively available for further processing in the motor vehicle; and
reproduce the data in the second data format in a text data structure as one of a readable format and a persistent database.

22. A device for computer-supported processing of data for one or more telematic services in a motor vehicle, comprising:
means for receiving data in a hierarchical data structure in a first predefined data format;
means for converting the received data from the first data format into a second data format in which the data are arranged in a tabular data structure; and
means for preparing the data contained in the second data format in a text data structure.
